(19) United States
(12) Patent Application Publication
(10) Pub. No.: US 2026/0359086 A1
(43) Pub. Date: Nov. 12, 2026

(54) EMULATION OF CLASSICAL-ANALOG HYBRID COMPUTERS FOR SOFTWARE AND HARDWARE DEVELOPMENT, TESTING, AND DEPLOYMENT PLATFORMS

(71) Applicant: International Business Machines Corporation, Armonk, NY (US)

(72) Inventors: Tristan Müller, Tübingen (DE); Frank Haverkamp, Tübingen (DE); Steven McJunkin, Rochester, MN (US); Rachel Mertz, Rochester, MN (US)

(21) Appl. No.: 18/599,144

(22) Filed: Mar. 7, 2024

(51) Int. Cl. G06F 9/455

(52) U.S. Cl. CPC G06F 9/455

(57) ABSTRACT

A classical processing system is emulated based on an emulated external clock. An analog processing system is emulated based on the emulated external clock. Information is transferred between the classical processing system and the analog processing system based on models of digital-to-analog converters and analog-to-digital converters.

### BACKGROUND

The present invention relates generally to the electrical, electronic and computer arts and, more particularly, to computer-aided software and hardware design, development, testing and deployment.

Emulators and simulators are an important tool for software and hardware design, development, and testing. Instruction set emulation of classical devices, such as processors based on a Von Neumann architecture, a Harvard architecture and the like, is used to emulate classical computing systems. Similarly, physical simulation/emulation of analog devices, such as qubit simulations, are used to simulate/emulate analog computing systems.

### BRIEF SUMMARY

Principles of the invention provide systems and techniques for emulation of classical-quantum hybrid computers for software and hardware development, testing, and deployment. In one aspect, an exemplary method includes the operations of emulating a classical processing system based on an emulated external clock; emulating an analog processing system based on the emulated external clock; and transferring information between the classical processing system and the analog processing system based on models of digital-to-analog converters and analog-to-digital converters.

In one aspect, a computer program product comprises one or more tangible computer-readable storage media and program instructions stored on at least one of the one or more tangible computer-readable storage media, the program instructions executable by a processor, the program instructions comprising emulating a classical processing system based on an emulated external clock; emulating an analog processing system based on the emulated external clock; and transferring information between the classical processing system and the analog processing system based on models of digital-to-analog converters and analog-to-digital converters.

In one aspect, an apparatus comprises a memory and at least one processor, coupled to the memory, and operative to perform operations comprising emulating a classical processing system based on an emulated external clock; emulating an analog processing system based on the emulated external clock; and transferring information between the classical processing system and the analog processing system based on models of digital-to-analog converters and analog-to-digital converters.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates a high-level view of a hybrid classical-analog computing architecture, in accordance with example embodiments;

FIG. 2 illustrates a high-level view of a hybrid classical-analog emulation platform, in accordance with example embodiments;

FIGS. 3A-3B show an example timing diagram for operation of the hybrid classical-analog emulation platform, in accordance with example embodiments;

FIG. 4A is a timing diagram for the classical CPU emulator, in accordance with example embodiments;

FIG. 4B is a timing diagram for the ADC emulator, in accordance with example embodiments;

FIG. 4C is a timing diagram for the DAC emulator, in accordance with example embodiments; and

FIG. 5 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that, in general terms, an exemplary method, according to an aspect of the invention, includes the operations of emulating a classical processing system based on an emulated external clock 254; emulating an analog processing system based on the emulated external clock 254; and transferring information between the classical processing system and the analog processing system based on models of digital-to-analog converters and analog-to-digital converters. The technical benefits include a system for emulating hybrid classical/analog computing architectures; an emulation framework which can emulate multiple distributed devices; a platform for software design, development, testing, and deployment; hardware design, development, testing, and deployment; or any combination of the foregoing; a system for emulating hybrid classical/analog computing architectures that provides for the identification of bottlenecks and improvements to latency of software and/or hardware, reductions in the cost of software development and hardware and the like; the debugging of potential flaws in the execution order of programs, such as when insufficient time has passed before fetching analog data and passing it to the digital processors; and estimation of energy consumption, such as by adding an estimated energy consumption of all current instructions and outgoing waves together.

It is worth noting that in one or more embodiments, the transferring of information between the classical processing system and the analog processing system is between the emulated classical processing system and the emulated analog processing system; however, aspects of the invention could be employed to facilitate information transfer between real systems and/or between a real system and an emulated system.

In one aspect, a computer program product comprises one or more tangible computer-readable storage media and program instructions stored on at least one of the one or more tangible computer-readable storage media, the program instructions executable by a processor, the program instructions comprising emulating a classical processing system based on an emulated external clock 254; emulating an analog processing system based on the emulated external clock 254; and transferring information between the classical processing system and the analog processing system based on models of digital-to-analog converters and analog-to-digital converters. The technical benefits include a system for emulating hybrid classical/analog computing architectures; an emulation framework which can emulate multiple distributed devices; a platform for software design, development, testing, and deployment; hardware design, development, testing, and deployment; or any combination of the foregoing; a system for emulating hybrid classical/analog computing architectures that provides for the identification of bottlenecks and improvements to latency of software and/or hardware, reductions in the cost of software development and hardware and the like; the debugging of potential flaws in the execution order of programs, such as when insufficient time has passed before fetching analog data and passing it to the digital processors; and estimation of energy consumption, such as by adding an estimated energy consumption of all current instructions and outgoing waves together.

In one aspect, an apparatus comprises a memory and at least one processor, coupled to the memory, and operative to perform operations comprising emulating a classical processing system based on an emulated external clock 254; emulating an analog processing system based on the emulated external clock 254; and transferring information between the classical processing system and the analog processing system based on models of digital-to-analog converters and analog-to-digital converters. The technical benefits include a system for emulating hybrid classical/analog computing architectures; an emulation framework which can emulate multiple distributed devices; a platform for software design, development, testing, and deployment; hardware design, development, testing, and deployment; or any combination of the foregoing; a system for emulating hybrid classical/analog computing architectures that provides for the identification of bottlenecks and improvements to latency of software and/or hardware, reductions in the cost of software development and hardware and the like; the debugging of potential flaws in the execution order of programs, such as when insufficient time has passed before fetching analog data and passing it to the digital processors; and estimation of energy consumption, such as by adding an estimated energy consumption of all current instructions and outgoing waves together. It is noted that analog computing platforms often perform computations exponentially faster than classical computing platforms. Thus, techniques are disclosed for synchronizing the analog computing emulation and the classical emulation. Techniques are also disclosed for synchronizing the emulation of the analog computing emulation or the classical emulation with an analog computing platform, a classical computing platform or both. For example, emulating a classical processing system based on an emulated external clock and emulating an analog processing system based on the emulated external clock ensure that the classical emulation and the analog computing emulation are synchronized and properly operate together.

In some instances, the system further includes at least one hardware component that generates an auxiliary output to be consumed by at least one of the emulated classical processing system and the emulated analog processing system. The technical benefits include the ability to bridge between the signal types of the classical processing system and the analog processing system. At least one of the emulating of the classical processing system and the emulating of the analog processing system further includes: obtaining the auxiliary output; obtaining an identification of an amount of time to be assumed for a generation of the output; and utilizing the auxiliary output and the identified amount of time in an emulation computation. In some such instances, the emulated analog processing system is implemented with a physical analog processing system. The technical benefits of the above features include the ability to bridge between the signal types of the classical processing system and the analog processing system and enable the classical emulator and the analog computing emulator to interoperate.

In one example embodiment, using digital-to-analog converter emulators 266-1, 266-2, 266-3, 266-4, the digital-to-analog converters are emulated based on the corresponding models; and, using the analog-to-digital converter emulators 270-1, 270-2, the analog-to-digital converters are emulated based on the corresponding models. The technical benefits include the ability to enable a system to emulate hybrid classical/analog computing architectures without the need to implement physical digital-to-analog converters, to bridge between the signal types of the classical processing system and the analog processing system and enable the classical emulator and the analog computing emulator to interoperate.

In one example embodiment, all devices in the emulation are advanced and causality is maintained using the emulated external clock 254. The technical benefits include the ability to ensure that the classical emulation and the analog computing emulation are cooperating properly and are properly synchronized, addressing issues such as the difference in processing time between classical processors and analog processors.

In one example embodiment, all devices in the emulation are advanced and synchronization is maintained using the emulated external clock 254. The technical benefits include the ability to ensure that the classical emulation and the analog computing emulation are properly synchronized.

In one example embodiment, the classical processing systems are implemented as classical instruction set emulators. The technical benefits include compatibility with classical instruction set emulator tools.

In one example embodiment, the classical instruction set emulators are augmented with hybrid classical/analog computing instructions. The technical benefits include expanding the capabilities of classical instruction set emulators to include hybrid classical/analog computing instructions.

In one example embodiment, analog devices are implemented by a physics-based simulation. The technical benefits include the ability to perform physical simulation/emulation of analog devices, such as qubits. The skilled artisan will be familiar with tools for physics-based simulations of analog devices, such as the SPICE (“Simulation Program with Integrated Circuit Emphasis”) general-purpose, open-source analog electronic circuit simulator, finite element software such as ANSYS® (registered mark of ANSYS, Inc.), and the like, and given the teachings herein can employ same to implement one or more embodiments. Examples of dedicated physics-based qubit simulation software include Qiskit and, more specifically, Qiskit-Metal, available from International Business Machines Corporation, Armonk, NY, USA, and PathWave Advanced Design System (ADS), available from Keysight Technologies, Santa Rosa, California, USA.

In one example embodiment, a software component is redesigned based on results of the emulating of the classical processing system and the emulating the analog processing system. The technical benefits include the ability to debug and redesign software for analog computers without the need to utilize a physical analog computer.

In one example embodiment, a hardware component is redesigned based on results of the emulating of the classical processing system and the emulating the analog processing system. The technical benefits include the ability to debug and redesign hardware for analog computers without the need to utilize a physical analog computer.

In one example embodiment, a software component is deployed based on results of the emulating of the classical processing system and the emulating the analog processing system. The technical benefits include the ability to debug and deploy software for analog computers without the need to utilize an analog computer.

In one example embodiment, a hardware component is deployed based on results of the emulating of the classical processing system and the emulating the analog processing system. The technical benefits include the ability to develop and debug hardware for analog computers for deployment.

In one example embodiment, troubleshooting is performed on a software component; and the software component is redesigned based on results of the emulating of the classical processing system and the emulating the analog processing system. The technical benefits include the ability to debug and deploy software for analog computers without the need to utilize an analog computer.

In one example embodiment, a peak power required by one or more devices when running a real program is estimated by measuring heat generation of the one or more devices when active; the measurements are tabulated; and the tabulated measurements are incorporated into the emulation. The technical benefits include the improvement of incorporating heat generation measurements into the emulating of the classical processing system and the emulating the analog processing system. Note that thermal simulations using finite elements, finite differences, and/or closed form solutions could be used in addition to, or in lieu of, thermal measurements in some cases.

In one example embodiment, a queue of analog signals to generate at a future time is maintained; and a specified analog signal from the queue of analog signals is generated with no gap between the specified analog signal and a preceding analog signal from the queue of analog signals. The technical benefits include the efficient utilization of the emulation platform and the accurate emulation of the classical processing system and the analog processing system, and efficiently bridge between the signal types of the classical processing system and the analog processing system.

Thus, techniques as disclosed herein can provide substantial beneficial technical effects. Some embodiments may not have these potential advantages and these potential advantages are not necessarily required of all embodiments. By way of example only and without limitation, one or more embodiments may provide one or more of:
a system for emulating hybrid classical/analog computing architectures;
an emulation framework which can emulate multiple distributed devices;
a platform for software design, development, testing, and deployment; hardware design, development, testing, and deployment; or any combination of the foregoing;
a system for emulating hybrid classical/analog computing architectures that provides for the identification of bottlenecks and improvements to latency of software and/or hardware, reductions in the cost of software development and hardware and the like;
the debugging of potential flaws in the execution order of programs, such as when insufficient time has passed before fetching analog data and passing it to the digital processors; and
estimation of energy consumption, such as by adding an estimated energy consumption of all current instructions and outgoing waves together.

A Quantum bit, or Qubit, is a quantum two-level system used to implement quantum gates, the basic operations of quantum computing. An analog device, as used herein, is any device which has analog signals as input and/or output and, therefore, includes quantum computers. Hybrid computing, as used herein, is computing that enables combinations of, for example, digital (such as classical) algorithms and quantum algorithms. As used herein, a real-time architecture (RTA) is a classical network including several central processing units (CPUs) that enable hybrid computing and that orchestrates quantum gates, generates waves for qubit control/readout, and processes measured qubit data.

Generally, a system for emulating hybrid classical/analog computing architectures is disclosed. An emulation framework which can emulate multiple distributed devices is created. These devices can be a mixture of digital and/or analog devices, such as quantum computers, inductance-capacitance circuits, and the like, and may be characterized by independent time scales. Exemplary embodiments can be used, for example, as a platform for software design, development, testing, and deployment; hardware design, development, testing, and deployment; or any combination of the foregoing. The emulations provided by one or more exemplary embodiments enable the development, execution and testing of software, the identification of bottlenecks and improvements to latency of software and/or hardware, reductions in the cost of software development and hardware, and the like.

A classical “real-time architecture (“RTA”)” acts as an interface between the digital and analog processors, and controls and reads out qubits from the quantum processor (where a “quantum-centric supercomputer” is a computer which partially runs tasks on the quantum computer and partially on a classical computer). Refer, for example, to the combination digital processor, the quantum processor and the RTA. In one example embodiment, the RTA also performs a number of digital computations in addition to or instead of digital computations performed by the digital processor. In some instances, RTA devices can have limited performance, and a dedicated CPU can be employed. “Real-time processing” of incoming qubit data can be an additional task of the RTA, such as the task of quantum error correction, instead of being provided by an external processor. In one example embodiment, RTA development is aided via instruction set emulations; instruction set emulators are extended to synchronized, distributed systems with different types of CPUs. In one or more embodiments, the RTA does not control the classical part. Suitable classical controllers which send/read the waves can, for example, have separate instruction and data memory, while other suitable controllers share memory for the software code and data.

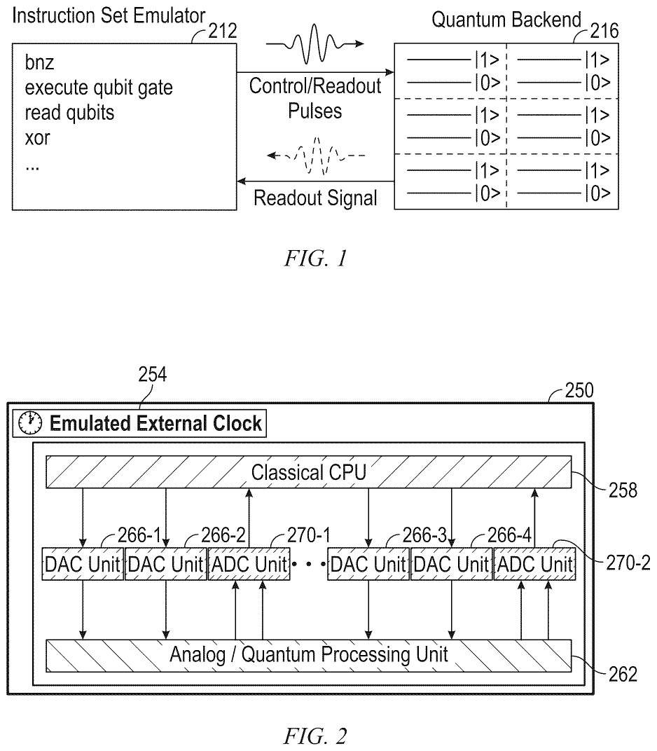

FIG. 1 illustrates a high-level view of a hybrid classical-analog computing architecture, in accordance with example embodiments. In one example embodiment, an instruction set emulator 212 issues control/readout pulses to a quantum backend 216, which responds with a readout signal to the instruction set emulator 212. Similarly, the quantum backend 216 issues control/readout pulses to the instruction set emulator 212, which can respond with a readout signal to the quantum backend 216.

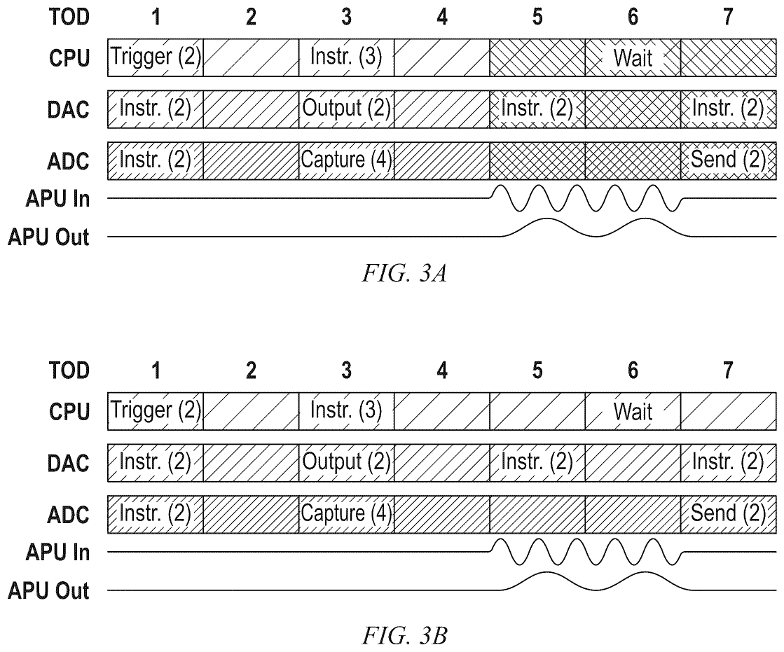

FIG. 2 illustrates a high-level view of a hybrid classical-analog emulation platform 250, in accordance with example embodiments. As noted above, the analog/quantum processing unit 262 can be any type of analog computing system. The components of the hybrid classical-analog emulation platform 250 are emulated by software running on a hardware processing platform. The classical CPU emulator 258 communicates with the analog/quantum processing unit 262 via multiple digital-to-analog converter (DAC) emulators 266-1, 266-2, 266-3, 266-4 and analog-to-digital converter (ADC) emulators 270-1, 270-2. An emulated external clock 254 provides a global clock for the hybrid classical-analog emulation platform 250. The emulated external clock 254 can be implemented as a time-of-day clock, an emulation of a conventional processor clock, a continuous, periodic pulse/signal, and the like. The emulated external clock 254 is used to keep all devices of the hybrid classical-analog emulation platform 250 synchronized; the classical CPU emulator 258 and the analog/quantum processing unit 262 each synchronize with the emulated external clock 254 and thereby remain synchronized with each other. The DAC emulators 266-1, 266-2, 266-3, 266-4 and the ADC emulators 270-1, 270-2 may either be synchronized with the emulated external clock 254 or may run in an asynchronous mode. It is noted that one or more of the emulators may be replaced by a corresponding hardware device that will perform the programmed functionality of the emulator. For example, any of the classical CPU emulator 258, the analog/quantum processing unit 262, the digital-to-analog converter (DAC) emulators 266-1, 266-2, 266-3, 266-4 and the analog-to-digital converter (ADC) emulators 270-1, 270-2 may be replaced with a corresponding hardware system.

The classical CPU emulator 258 operates similar to a conventional classical emulator, but is configured to execute instructions in a manner synchronized with the emulated external clock 254. This can be accomplished by giving the classical CPU emulator 258 a particular time at which an instruction is to be triggered, a particular time at which an execution of an instruction is to be completed, a time budget (such as two milliseconds (ms)) for executing an arbitrary number of instructions, and the like. Similarly, the analog/analog emulator 262 operates similar to a conventional analog emulator, but is configured to execute instructions in a manner synchronized with the emulated external clock 254, as described above. The timing parameters that define the execution time of instructions, analog-to-digital and digital-to-analog conversions, and the like can be configured in advance of the emulation or can be determined during the emulation. (In addition to timing information, the amount of data produced can also be determined.)

In one example embodiment, the timing parameters are a combination of electronic latency (such as induced by electrical attenuators, electrical cables, and the like; typically a fixed value), analog CPU response time (typically a fixed value) and the duration of the pulse (typically a variable value). The fixed values can either be measured or estimated, e.g. via a simulation of the analog CPU or by estimating cable lengths. In one example embodiment, the variable durations are determined during runtime and are given by a fixed relation, such as, if a pulse takes x cycles, add an additional y cycles for the readout. (In one example embodiment, x=y. Thus, if a pulse takes x cycles, an additional x cycles are added for the readout.) Messages can be sent between the classical controllers, but will be subjected to a fixed electronic latency, such as that induced by electrical cables (including the maximum transmission latency when broadcasting signals on a star topology), processing time (such as checking a checksum), and the like.

In addition, whereas the processing time of a given instruction type for a classical processor generally does not vary over time (exceptions being, for example, operating at a different clock frequency, power level, and the like), the processing time of a given instruction type for an analog processor can vary over time. For example, sending shorter or longer pulses to the analog computer can cause the processing time of a given instruction type for an analog processor to vary over time. If a longer signal is sent into the analog processor, it may be desirable to capture the corresponding outcoming signal over a longer time period. As a result, the message from the analog-to-digital converter (ADC) emulators 270-1, 270-2 to the classical CPU emulator 258 is delayed and the classical CPU emulator 258 will have to wait longer for the results to be captured. This enables programmers to have a mechanism to vary pulse schemes in an emulation environment prior to operating in sensitive hardware.

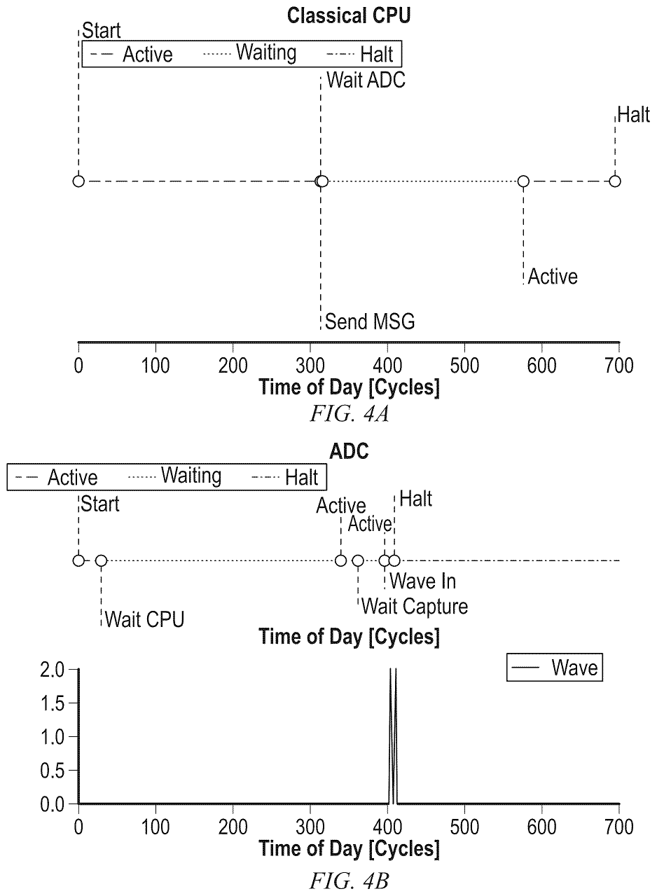

FIGS. 3A-3B show an example timing diagram for operation of the hybrid classical-analog emulation platform 250, in accordance with example embodiments. In the example embodiment of FIG. 3A, the emulated external clock 254 is a time-of-day (TOD) clock where each time period (also referred to as a period herein) is sequentially numbered from 1 to 7 (for the time period illustrated in FIG. 3A). Each emulator is run by “advancing” a number of TOD cycles. In one example embodiment, each classical device, such as the classical CPU emulator 258, executes instructions up to the current emulated TOD; analog devices, such as the analog/analog emulator 262, “pre-compute” their future behavior; that is, for example, computing a result and then outputting the result at the specified time (analog information is only available up to the current TOD). This “pre-computing” enables the independent computation of the output of the analog/quantum processing unit 262 as efficiently as possible, such as based on whether a coarser or a finer time scale for the physical simulation is desired (compared to the overall emulator time scale). The computations of the analog/quantum processing unit 262 are solved on that “physical time scale” in one go and then the result(s) is/are made available once the classical CPU emulator 258 has caught up with the processing of the analog/quantum processing unit 262. In principle, this enables the coupling of the exemplary analog/quantum processing unit 262 to a variety of “external processes.” For example, field-programmable gate arrays (FPGAs) can be modeled in a similar manner; data is sent to an emulated FPGA, the emulated FPGA responds with “the output after N cycles” and then the emulation of the analog/quantum processing unit 262 proceeds with the output from the emulated FPGA.

In FIGS. 3A-3B, the activities of the classical CPU emulator 258 are shown in the bar labeled CPU. As illustrated, the classical CPU emulator 258 executes a trigger instruction over the first two time periods (periods 1-2) that triggers DAC emulator 266-1 to convert information (such as an instruction, data or a combination of an instruction and data) to an analog signal that may be consumed by the analog/quantum emulator 262. While waiting for a response from the analog/quantum emulator 262, the classical CPU emulator 258 has available time budget to execute an instruction that requires three time periods (periods 3-5). As the response from the analog/quantum emulator 262 is still not available by time period 6, the classical CPU emulator 258 executes a wait instruction starting at time period 6.

As described above, the classical CPU emulator 258 triggers DAC emulator 266-1 to convert information into an analog signal that is consumed by the analog/quantum emulator 262. In response to the execution of the trigger instruction, the DAC emulator 266-1 executes an output instruction (periods 3-4) which simulates the generation of an analog signal (APU In) that is received by the analog/quantum emulator 262 during time periods 5-6. The wave (signal) to the analog/quantum emulator 262 can be output for, for example, 100 ns. The emulation by the DAC emulators 266-1, 266-2, 266-3, 266-4 and the ADC emulators 270-1, 270-2 can be based on an estimated propagation delay, a detailed analysis of the corresponding circuit, and the like. Similar emulations can be performed for different types of devices coupled to the classical CPU emulator 258, the analog/quantum emulator 262 or both.

The analog/quantum emulator 262 executes an instruction corresponding to the analog input signal and generates an analog output signal (APU out). The analog output signal is generated during a timeframe that conforms to the timing of the analog/quantum processor being simulated. For example, if the analog/quantum processor being simulated would require 10 ns to produce the analog output signal, the analog/quantum emulator 262 will wait 10 ns before outputting the signal. As illustrated in FIG. 3A, the analog output signal is generated and available during part of time period 5 and during time period 6.

Turning to FIG. 3B, the ADC emulator 270-1 executes a capture instruction during periods 3-6 and converts the analog output signal to digital for consumption by the classical CPU emulator 258. (It is noted that the classical CPU emulator 258 issues an instruction to the ADC emulator 270-1 to capture the analog output signal in advance of the ADC emulator 270-1 executing the capture instruction.) The ADC emulator 270-1 then executes a send instruction during periods 7-8 to send the captured data to the classical CPU emulator 258. For example, a wave (signal; not shown) may be output to the classical CPU emulator 258 for 50 ns.

As each component of the hybrid classical-analog emulation platform 250 is emulated, the results may be computed at a speed faster than the device being emulated, but the output will be generated commensurate with the speed of the emulated device.

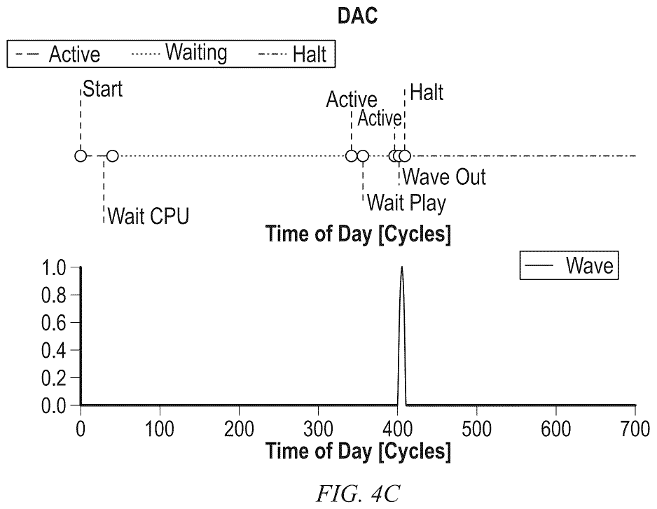

FIG. 4A is a timing diagram for the classical CPU emulator 258, in accordance with example embodiments. In the timing diagram of FIG. 4A, the time of day is defined in terms of cycles. As illustrated in FIG. 4A, the classical CPU emulator 258 is active from cycles 0 to 313 on the x-axis, sends a message to one of the DAC emulators 266-1, 266-2, 266-3, 266-4 to convert information destined for the analog/quantum emulator 262 to analog and then waits for a response to the message. The classical CPU emulator 258 enters the active state at cycle 576 on the x-axis where the response is received via one of the ADC emulators 270-1, 270-2 and halts at cycle 695 on the x-axis.

FIG. 4B is a timing diagram for the ADC emulator 270-1, 270-2, in accordance with example embodiments. In the timing diagram of FIG. 4B, the time of day is defined in terms of cycles. As illustrated in FIG. 4B, the ADC emulator 270-1, 270-2 is active from cycles 0 to 29 on the x-axis due to an earlier activity, and then waits from cycle 30 to 338 on the x-axis for an instruction from the classical CPU emulator 258. At cycles 338-359 on the x-axis, an instruction from the classical CPU emulator 258 is received indicating that a signal from the analog/quantum emulator 262 is to be captured. The ADC 270-1, 270-2 waits for the arrival of the analog signal from the analog/quantum emulator 262 during cycles 359 to 393 on the x-axis. At cycle 394 on the x-axis, the analog signal arrives and the ADC emulator 270-1, 270-2 begins the capture of the analog signal. At cycle 407 on the x-axis, the captured wave is converted to a digital value and the digital value is provided to the classical CPU emulator 258 starting at cycle 408 on the x-axis.

In one example embodiment, the ADC emulators 270-1, 270-2 and the DAC emulators 266-1, 266-2, 266-3, 266-4 operate in a two-step process: when the ADC emulators 270-1, 270-2 and the DAC emulators 266-1, 266-2, 266-3, 266-4 receive a message, the active state is resumed. The message indicates when the ADC emulator 270-1, 270-2 and the DAC emulator 266-1, 266-2, 266-3, 266-4 is to act in the future, such as when to start to send a signal, when to capture a wave (such as at time 500) and the like. Thus, a first step is to wait for a message and a second step is to wait for the future action time indicated in the message to perform the corresponding operation. This guarantees that the ADC emulator 270-1, 270-2 and the DAC emulator 266-1, 266-2, 266-3, 266-4 is synchronized even in the event that the message latencies are different.

FIG. 4C is a timing diagram for the DAC emulator 266-1, 266-2, 266-3, 266-4, in accordance with example embodiments. In the timing diagram of FIG. 4C, the time of day is defined in terms of cycles. As illustrated in FIG. 4C, the DAC emulator 266-1, 266-2, 266-3, 266-4 is active from cycles 0 to 39 on the x-axis due to an earlier activity, and then waits from cycle 40 to 338 on the x-axis for an instruction from the classical CPU emulator 258. At cycles 338-353 on the x-axis, an instruction from the classical CPU emulator 258 is received indicating that a signal is to be provided to the analog/quantum emulator 262 at a specified future time period. The DAC emulator 266-1, 266-2, 266-3, 266-4 waits until the specified time period and then generates an analog signal to the analog/quantum emulator 262 during cycles 393 to 404 on the x-axis. At cycle 405 on the x-axis, the generation of the analog signal is halted.

In one example embodiment, the power consumption and heat generation of a physical device are measured when executing instructions, playing waves (signals) and the like. The measurements are tabulated and incorporated into the simulation. It is then possible to estimate the peak power required by a variety of devices when running a real program. This is pertinent, for example, when moving devices to cold (cryogenic) temperatures, where strict requirements for power consumption and heat generation need to be met. The simulation can show, for example, whether there is some leeway in meeting the requirements, such as an instance where not all controllers will be under full load the whole time for a particular use case, and there may be substantial reserve in meeting the requirements for power consumption and heat generation.

In one example embodiment, an average energy consumption is estimated for each single instruction/operation. If there is a real implementation of the corresponding device, each instruction is executed N times, the energy consumption is measured and the result is divided by N.

In one example embodiment, a hardware simulation of the hardware description language (HDL) is performed and the simulator determines how many state changes are occurring while an instruction is executed. Assuming that each state change requires power and no state change does not, a rough estimate may be obtained.

In one example embodiment, an additional digital processor is implemented for, for example, generating analog signals immediately, at a scheduled future time and the like. One application is to use the additional digital processor for small processing tasks to save time by avoiding the message latency between units, such as between the digital-to-analog converter (DAC) emulators 266-1, 266-2, 266-3, 266-4 and the analog-to-digital converter (ADC) emulators 270-1, and the classical CPU (e.g. a quick yes/no decision based on an incoming wave). In one example embodiment, the additional processor provides support for issuing analog signals from the DACs emulators 266-1, 266-2, 266-3, 266-4 with no gap between successive analog signals. If the full wave for a first instruction has not been played, a second instruction attempting to play a wave will put the data describing the second wave into a queue associated with the additional processor; the second wave will then be played directly after the playing of the first wave is completed. This enables the playing of waves back-to-back without any gaps, e.g. three instructions can be executed back-to-back that result in playing waves of 10 cycles each. Executing the instructions will take 2+2+2=6 cycles in total, while playing the waves will take 30 cycles in total. After the first instruction, the first wave is played immediately (for example, during cycles 3-12), the second wave will begin 10 cycles later (for example, during cycles 13-22, after the first wave is completed), and the third wave will begin another 10 cycles later (for example, during cycles 23-32; after the second wave is completed). Thus, the instructions for playing the waves would take 6 cycles to execute, whereas the waves would be played for 30 cycles. The controller may continue with any other instruction(s) while the waves are playing. The queue is limited in size (to hold, for example, five wave entries). If a sixth entry would be added, the controller will wait until the first wave has been completed, and will then add the sixth wave to the queue and continue with the next instruction.

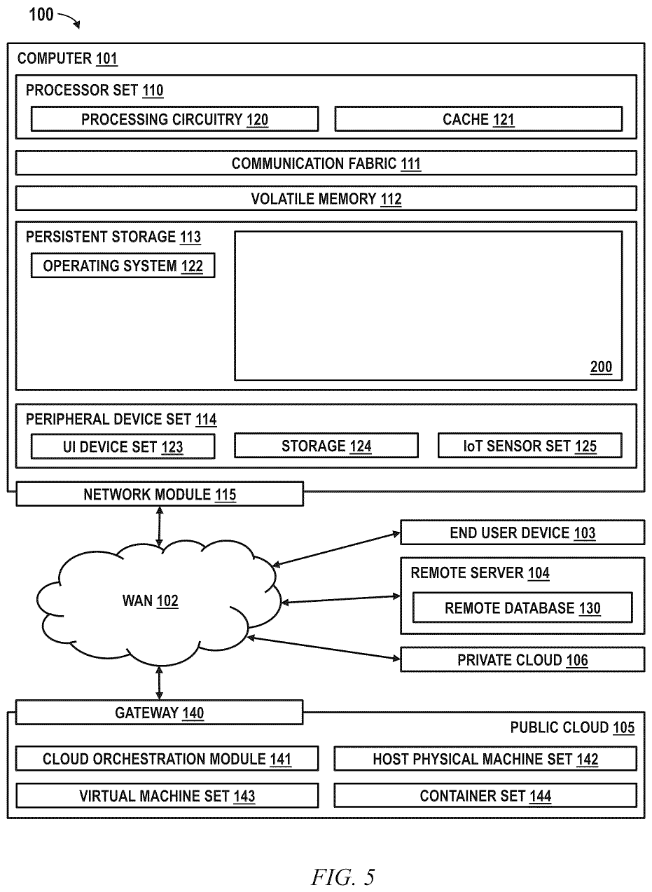

It is worth noting that coupling to other external processes/accelerators is possible, such as a field programmable gate array (FPGA) or a graphics processing unit (GPU)—generally, some entity which it is not necessarily desired to model exactly, but where some input is provided, some output is obtained, and it can be determined that “this took N cycles.” It is also worth noting that partially coupling to real-world devices is possible. The skilled person can adapt known coupling techniques analogous to those discussed with regard to FIG. 5, for example.

Reference should now be had to FIG. 5.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as hybrid classical-analog emulator 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
emulating a classical processing system based on an emulated external clock;
emulating an analog processing system based on the emulated external clock; and
transferring information between the classical processing system and the analog processing system based on models of digital-to-analog converters and analog-to-digital converters.

2. The method of claim 1, further comprising:
emulating, using digital-to-analog converter emulators, the digital-to-analog converters based on the corresponding models; and
emulating, using the analog-to-digital converter emulators, the analog-to-digital converters based on the corresponding models.

3. The method of claim 1, further comprising advancing all devices in the emulation and maintaining causality using the emulated external clock.

4. The method of claim 1, further comprising advancing all devices in the emulation and maintaining synchronization using the emulated external clock.

5. The method of claim 1, wherein the classical processing systems are implemented as classical instruction set emulators.

6. The method of claim 5, wherein the classical instruction set emulators are augmented with hybrid classical/analog computing instructions.

7. The method of claim 1, wherein analog devices are implemented by a physics-based simulation.

8. The method of claim 1, further comprising redesigning a software component based on results of the emulating of the classical processing system and the emulating the analog processing system.

9. The method of claim 1, further comprising redesigning a hardware component based on results of the emulating of the classical processing system and the emulating the analog processing system.

10. The method of claim 1, further comprising deploying a software component based on results of the emulating of the classical processing system and the emulating the analog processing system.

11. The method of claim 1, further comprising deploying a hardware component based on results of the emulating of the classical processing system and the emulating the analog processing system.

12. The method of claim 1, further comprising:
troubleshooting a software component; and
redesigning the software component based on results of the emulating of the classical processing system and the emulating the analog processing system.

13. The method of claim 1, further comprising estimating a peak power required by one or more devices when running a real program by:
measuring heat generation of the one or more devices when active;
tabulating the measurements; and
incorporating the tabulated measurements into the emulation.

14. The method of claim 1, wherein the transferring information between the classical processing system and the analog processing system further comprises:
maintaining a queue of analog signals to generate at a future time;
generating a specified analog signal from the queue of analog signals with no gap between the specified analog signal and a preceding analog signal from the queue of analog signals.

15. A computer program product, comprising:
one or more tangible computer-readable storage media and program instructions stored on at least one of the one or more tangible computer-readable storage media, the program instructions executable by a processor, the program instructions comprising:
emulating a classical processing system based on an emulated external clock;
emulating an analog processing system based on the emulated external clock; and
transferring information between the classical processing system and the analog processing system based on models of digital-to-analog converters and analog-to-digital converters.

16. The computer program product of claim 15, wherein the program instructions further comprise:
emulating, using digital-to-analog converter emulators, the digital-to-analog converters based on the corresponding models; and
emulating, using the analog-to-digital converter emulators, the analog-to-digital converters based on the corresponding models.

17. The computer program product of claim 15, wherein the program instructions further comprise advancing all devices in the emulation and maintaining causality using the emulated external clock.

18. The computer program product of claim 15, wherein the program instructions further comprise advancing all devices in the emulation and maintaining synchronization using the emulated external clock.

19. A system comprising:
a memory; and
at least one processor, coupled to said memory, and operative to perform operations comprising:
emulating a classical processing system based on an emulated external clock;
emulating an analog processing system based on the emulated external clock; and
transferring information between the classical processing system and the analog processing system based on models of digital-to-analog converters and analog-to-digital converters.

20. The system of claim 19, wherein the system further comprises at least one hardware component that generates an auxiliary output to be consumed by at least one of the emulated classical processing system and the emulated analog processing system, wherein at least one of the emulating of the classical processing system and the emulating of the analog processing system further comprises: obtaining the auxiliary output; obtaining an identification of an amount of time to be assumed for a generation of the output; and utilizing the auxiliary output and the identified amount of time in an emulation computation.

21. The system of claim 19, wherein the emulated analog processing system is implemented with a physical analog processing system.

22. The system of claim 19, the operations further comprising:
emulating, using digital-to-analog converter emulators, the digital-to-analog converters based on the corresponding models; and
emulating, using the analog-to-digital converter emulators, the analog-to-digital converters based on the corresponding models.

23. The system of claim 19, the operations further comprising advancing all devices in the emulation and maintaining causality using the emulated external clock.

24. The system of claim 19, the operations further comprising advancing all devices in the emulation and maintaining synchronization using the emulated external clock.

25. The system of claim 19, the operations further comprising:
troubleshooting a software component; and
redesigning the software component based on results of the emulating of the classical processing system and the emulating the analog processing system.
